(19) United States
(12) Patent Application Publication
(10) Pub. No.: US 2023/0273099 A1
(43) Pub. Date: Aug. 31, 2023

(54) TISSUE PROCESSOR AND METHOD OF PROCESSING TISSUE SAMPLE

(71) Applicant: LEICA BIOSYSTEMS NUSSLOCH GMBH, Nussloch (DE)

(72) Inventors: Changhong WU, Shanghai (CN); Lei PEI, Shanghai (CN); Yuanyuan WANG, Shanghai (CN); Chun JIN, Shanghai (CN)

(21) Appl. No.: 18/009,051

(22) PCT Filed: Jun. 15, 2020
(86) PCT No.: PCT/CN2020/096222

§ 371 Date: Dec. 8, 2022

(51) Int. Cl. G01N 1/30; B01L 3/16; B01L 3/00; B01L 7/00

(52) U.S. Cl. CPC G01N 1/30; B01L 3/16; B01L 3/508; B01L 7/52; B01L 2300/1805; B01L 2300/043; B01L 2300/046

(57) ABSTRACT

Disclosed are a tissue processor and a method of processing a tissue sample by a tissue processor. The tissue processor includes a retort adapted to contain a material to be processed and having an opening, a retort lid configured to open and close the opening of the retort, and a heater coupled to the retort lid so as to heat the retort lid.

### CROSS-REFERENCE TO RELATED APPLICATIONS

The present application is a national phase entry under 35 USC § 371 of International Application PCT/CN2020/096222, filed Jun. 15, 2020, the entire disclosure of which is incorporated herein by reference.

### TECHNICAL FIELD

The present disclosure relates to a field of tissue processing, and particular to a tissue processor and a method of processing a tissue sample by a tissue processor.

### BACKGROUND

A tissue processor is used for processing biological tissues. Such a tissue processor has a retort containing tissues and a retort lid which seals the retort when the tissue processor performs protocols. In a protocol, the tissue is processed by formalin, alcohol and xylene, and embedded in paraffin. After that, the tissue may be stabilized, and further sectioned by a microtome. The tissue processor may also perform a cleaning protocol to clean the retort so as to process other tissues.

During the preparation of the tissue specimen and the cleaning of the retort, the reagents used in the retort are heated such that the retort lid has a much lower temperature than that inside the retort. Vapor/fume of a reagent may be collected by the retort lid as a condensate which may fall into a next, different reagent. Moreover, reagent fumes may escape into the surrounding atmosphere once the retort lid is opened after a protocol is finished, causing health hazard to an operator.

WO03/029845A2 describes a tissue processor for processing tissue samples with a heating mat 55 for heating the retort.

EP1279444B1 describes a tissue processor for processing specimens of biological tissue with a fume collecting arrangement with vents on the top of the retort.

### SUMMARY

The present disclosure seeks to solve at least one of the problems that exist in the related art to at least some extent. Accordingly, a tissue processor and a method of processing a tissue sample by a tissue processor are provided.

In an aspect, the present disclosure provides in embodiments a tissue processor, including a retort adapted to contain a material to be processed and having an opening, a retort lid configured to open and close the opening of the retort, and a heater coupled to the retort lid so as to heat the retort lid.

With the tissue processor according to embodiments of the present disclosure, the heater is used to heat the retort lid and a difference between a temperature inside the retort and a temperature of the retort lid is decreased, so as to prevent the collection of vapor condensate on the retort lid, resulting in less carryover of a reagent into the next, different reagent.

In some embodiments, the retort lid includes an outer cover and an inner plate, and the heater is disposed within a chamber defined by the outer cover and the inner plate.

In some embodiments, the heater is a heating pad attached onto a surface of the inner plate.

In some embodiments, the inner plate is a heat-conducting plate.

In some embodiments, a heat insulation layer is disposed within the chamber and positioned between the outer cover of the retort lid and the heater.

In some embodiments, the retort lid is pivotably connected to the retort.

In some embodiments, a periphery of the retort lid exceeds a periphery of the opening when the retort lid is closed.

In some embodiments, the retort has a flange at the opening, and the retort lid has a lock engaged with the flange when the retort lid is closed.

In some embodiments, the tissue processor further includes a conduit fluidly connected to the retort to introduce a fluid into the retort or discharge the fluid from the retort.

In some embodiments, the tissue processor further includes a controller electrically coupled to the heater and configured to control the heater to heat the retort lid.

In some embodiments, the controller includes: a memory device having instructions stored therein, and a processor configured to execute the instructions to implement any of the following operations of: processing the tissue sample with formalin, processing the tissue sample with alcohol, processing the tissue sample with xylene, processing the tissue sample with paraffin, cleaning the retort with xylene, cleaning the retort with alcohol, and drying the retort.

In some embodiments, the heater is controlled so as not to heat the retort lid when the tissue sample is processed with formalin.

In some embodiments, the heater is controlled to heat the retort lid when the tissue sample is processed with alcohol.

In some embodiments, the heater is controlled to heat the retort lid when the tissue sample is processed with xylene.

In some embodiments, the heater is controlled to heat the retort lid when the tissue sample is processed with paraffin.

In some embodiments, the heater is controlled to heat the retort lid when the retort is cleaned with xylene.

In some embodiments, the heater is controlled to heat the retort lid when the retort is cleaned with alcohol.

In some embodiments, the heater is controlled to heat the retort lid when the retort is dried.

In some embodiments, the operations are programmable to set a predetermined temperature for each of the operations independently.

In another aspect, the present disclosure provides in embodiments a method of processing a tissue sample by the tissue processor as described above.

It is to be understood that both the foregoing general description and the following detailed description are explanatory and shall not be construed to limit the present disclosure.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a schematic diagram of a tissue processor according to some embodiments of the present disclosure;

FIG. 2 is a schematic diagram of a tissue processor according to some other embodiments of the present disclosure; and

FIG. 3 is a diagram showing a heating status control for operations performed by a tissue processor according to some embodiments of the present disclosure.

### DETAILED DESCRIPTION

Embodiments of the present disclosure are described in detail below, examples of which are illustrated in the drawings. The embodiments described herein with reference to drawings are explanatory, and used to generally understand the present disclosure. The embodiments shall not be construed to limit the present disclosure.

It should be illustrated that, terms used in the present disclosure are only for the purpose of describing specific embodiments, but should not be construed to limit the present disclosure. As used in embodiments of the present disclosure and the appended claims, “a”, “an” and “the” in singular forms mean including plural forms as well, unless clearly indicated in the context otherwise. It should also be understood that, as used herein, the term “and/or” represents and contains any one and all possible combinations of one or more associated listed items.

In the specification, unless specified or limited otherwise, relative terms such as “inner”, “outer”, “up” as well as derivative thereof should be construed to refer to the orientation as then described or as shown in the drawings under discussion. These relative terms are for convenience of description and do not require that the present disclosure be constructed or operated in a particular orientation.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

A tissue processor and a method of processing a tissue sample by a tissue processor provided in the embodiments of the present disclosure are described below with reference to the drawings.

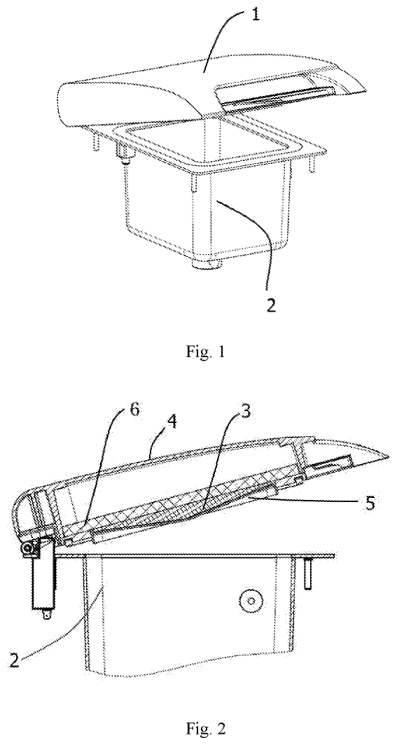

FIG. 1 is a schematic diagram of a tissue processor according to some embodiments of the present disclosure, and FIG. 2 is a schematic diagram of a tissue processor according to some other embodiments of the present disclosure.

In some embodiments, the tissue processor includes a retort lid 1, a retort 2 and a heater (not shown in FIG. 1). The retort 2 is adapted to contain a material, i.e., a tissue sample to be processed and has an opening. The retort lid 1 is configured to open and close the opening of the retort 2. Specifically, the retort lid 1 is connected to the retort 2 and moveable between a lowered position covering the opening and a raised position to allow access to the interior of the retort 2. In an embodiment, the retort lid 1 is pivotably connected to the retort 2. For example, a hinge may be used to connect the retort lid 1 to the retort 2. The heater is coupled to the retort lid 1 so as to heat the retort lid 1. Specifically, the heater may be contained in the retort lid 1 or attached to the retort lid 1 from outside.

As shown in FIG. 2, the heater may be a heating pad 3. The retort lid 1 includes an outer cover 4 and an inner plate 5, and the heating pad 3 is disposed within a chamber defined by the outer cover 4 and the inner plate 5. Further, the heating pad 3 is attached onto a surface, i.e., an upwardly facing surface, of the inner plate 5. Specifically, the inner plate 5 is a heat-conducting plate made of a heat-conducting material. For example, the inner plate 5 is made of a stainless steel. In another embodiment, the inner plate 5 may be covered by a protective coating to protect the inner plate 5 from being corroded by fluids for processing a tissue sample.

Further, a heat insulation layer 6 is disposed within the chamber and positioned between the outer cover 4 of the retort lid 1 and the heating pad 3. Specifically, the heat insulation layer 6 is disposed on the heating pad 3 so as to prevent an operator from being burned due to a high temperature of the outer cover 4 of the retort lid 1 and to avoid heat dissipation. The heat insulation layer 6 may be made of any suitable insulating material, such as a rubber and a plastic.

Further, a periphery of the retort lid 1 exceeds a periphery of the opening when the retort lid 1 is closed. In other words, the periphery of the retort lid 1 extends beyond the periphery of the opening when the retort lid 1 is closed. As shown in FIG. 2, the retort 2 has a flange at the opening, and the retort lid 1 has a lock engaged with the flange when the retort lid 1 is closed.

After a basket with tissues is placed in the retort 2 of the tissue processor, the tissues may be processed with formalin, alcohol, xylene and paraffin. After the tissues are taken out, the retort 2 may be cleaned with xylene and alcohol, and further dried. In this case, the basket used may be placed in the retort 2 and cleaned together. The fluids are introduced into or discharged from the retort 2 by a conduit(s) fluidly connected to the retort 2. The fluid may be heated before it flows into the retort. Alternatively, the fluid may be heated by a heater arranged in the retort.

Further, the tissue processor may include other components, such as a level sensor, a temperature sensor, a stirrer, a valve and a pump, which have known structures and functions in the art.

With the tissue processor according to embodiments of the present disclosure, the heater 3 is provided to heat the retort lid 1 such that a temperature difference between the retort lid 1 and the interior of the retort 2 may be smaller to prevent the collection of vapor condensate on the retort lid 2, resulting in less carryover of a reagent residue into the next, different reagent. Moreover, there is no need to heat the retort lid 1 to a high temperature. For example, the tissues may be processed at 60° C. in the retort 2, and the retort lid 1 may be heated to a temperature equal to or less than 60° C., for example to 45° C. The heating of the retort lid 1 is mild and will not negatively affect the quality of the processed tissues. Further, since the reagent residuals in the retort 2 or the retort lid 1 are reduced, reagent fume levels are also reduced.

In some embodiments, the tissue processor further includes a controller electrically coupled to the heater and configured to control the heater to heat the retort lid. The controller includes a memory device having instructions stored therein, and a processor configured to execute the instructions to implement any of the operations of processing the tissue sample with formalin, processing the tissue sample with alcohol, processing the tissue sample with xylene, processing the tissue sample with paraffin, cleaning the retort with xylene, cleaning the retort with alcohol, and drying the retort. With the controller of the tissue processor, the operations/steps are programmable to set a predetermined temperature of each of the operations/steps independently, so as to further reduce the fume (e.g., formalin and xylene) level.

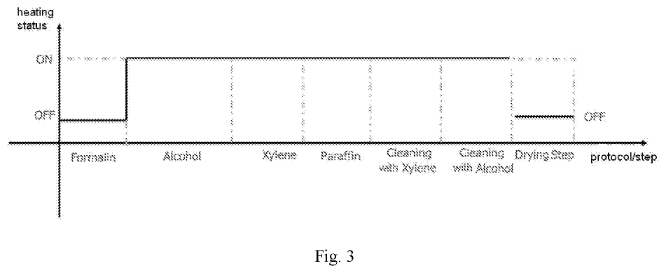

FIG. 3 is a diagram showing a heating status control for operations (e.g., a protocol or a step) performed by a tissue processor according to some embodiments of the present disclosure.

As shown in FIG. 3, the heater is controlled so as not to heat the retort lid when the tissue sample is processed with formalin, that is, a heating status of the formalin step is off. Since formalin may cause health hazard to an operator, the heater may be controlled not to heat the retort lid at this step to reduce the formalin fume level. Further, as shown in FIG. 3, the heater is controlled to heat the retort lid when the tissue sample is processed with alcohol, that is, a heating status of the alcohol step is on. Further, the heater is controlled to heat the retort lid when the tissue sample is processed with xylene, that is, a heating status of the xylene step is on. Further, the heater is controlled to heat the retort lid when the tissue sample is processed with paraffin, that is, a heating status of the paraffin step is on. Further, the heater is controlled to heat the retort lid when the retort is cleaned with xylene, that is, a heating status of a cleaning step with xylene is on. Further, the heater is controlled to heat the retort lid when the retort is cleaned with alcohol, that is, a heating status of a cleaning step with alcohol is on. Further, the heater is controlled so as not to heat the retort lid when the retort is dried, that is, a heating status of a drying step is off. After the retort is cleaned, the controller may control the heater to stop heating the retort lid to save energy and allow the retort lid to be cooled. Further, the controller may control the heater to heat the retort lid to a predetermined temperature for each of the steps, operations or protocols independently.

In an embodiment, the retort lid of the tissue processor may not be opened until a single protocol is finished. A single protocol may consist of any step/operation shown in FIG. 3. For example, a protocol may consist of steps of processing the tissue sample with formalin, alcohol, xylene and paraffin. For another example, a protocol may consist of steps of cleaning the retort with xylene and alcohol, and a drying step.

As shown in FIG. 3, the present disclosure also provides a control method for heating the retort lid of the tissue processor, the tissue processor is controlled, for example by a controller, so as not to heat the retort lid when the tissue sample is processed with formalin. Further, the tissue processor is controlled to heat the retort lid when the tissue sample is processed with alcohol. Further, the tissue processor is controlled to heat the retort lid when the tissue sample is processed with xylene. Further, the tissue processor is controlled to heat the retort lid when the tissue sample is processed with paraffin. Further, the tissue processor is controlled to heat the retort lid when the retort is cleaned with xylene. Further, the tissue processor is controlled to heat the retort lid when the retort is cleaned with alcohol. Further, the tissue processor is controlled so as not to heat the retort lid when the retort is dried.

With a method of processing a tissue sample by a tissue processor as described above, by controlling the heater to heat the retort lid, particularly to a predetermined temperature for each of the steps/operations independently, a temperature difference between the retort lid and the interior of the retort is decreased, so as to prevent the collection of vapor condensate on the retort lid, thus reducing residuals dramatically and minimising the escape of unexpected fumes. Moreover, with the control method for heating the retort lid of the tissue processor, the formalin fume level may be further reduced.

Further, the processor of the controller may be a personal computer processor. The controller may contain a number of redefined protocols (or steps) for processing tissue in the memory device including all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. The processor suitable for the execution of a computer program/instruction include, by way of example, both general and special purpose microprocessors, and any one or more processors of any kind of digital computer. Generally, a processor will receive instructions and data from a read-only memory, or a random-access memory, or both.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. Thus, the appearances of above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples described in the specification, as well as features of embodiments or examples, without conflicting, may be combined by one skilled in the art.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A tissue processor for processing a tissue sample, the tissue processor comprising:
a retort adapted to contain a material to be processed and having an opening,
a retort lid configured to open and close the opening of the retort, and
a heater coupled to the retort lid so as to heat the retort lid.

2. The tissue processor according to claim 1, wherein the retort lid comprises an outer cover and an inner plate, and the heater is disposed within a chamber defined by the outer cover and the inner plate.

3. The tissue processor according to claim 2, wherein the heater is a heating pad attached onto a surface of the inner plate.

4. The tissue processor according to claim 2, wherein the inner plate is a heat-conducting plate.

5. The tissue processor according to claim 2, wherein a heat insulation layer is disposed within the chamber and positioned between the outer cover of the retort lid and the heater.

6. The tissue processor according to claim 1, wherein the retort lid is pivotably connected to the retort.

7. The tissue processor according to claim 1, wherein a periphery of the retort lid exceeds a periphery of the opening when the retort lid is closed.

8. The tissue processor according to claim 1, wherein the retort has a flange at the opening, and the retort lid has a lock engaged with the flange when the retort lid is closed.

9. The tissue processor according to claim 1, further comprising a conduit fluidly connected to the retort to introduce a fluid into the retort or discharge the fluid from the retort.

10. The tissue processor according to claim 1, further comprising a controller electrically coupled to the heater and configured to control the heater to heat the retort lid.

11. The tissue processor according to claim 10, wherein the controller comprises:
a memory device having instructions stored therein, and
a processor configured to execute the instructions to implement any of the following operations of:
processing the tissue sample with formalin,
processing the tissue sample with alcohol,
processing the tissue sample with xylene,
processing the tissue sample with paraffin,
cleaning the retort with xylene,
cleaning the retort with alcohol, and
drying the retort.

12. The tissue processor according to claim 11, wherein the heater is controlled so as not to heat the retort lid when the tissue sample is processed with formalin.

13. The tissue processor according to claim 11, wherein the heater is controlled to heat the retort lid when the tissue sample is processed with alcohol.

14. The tissue processor according to claim 11, wherein the heater is controlled to heat the retort lid when the tissue sample is processed with xylene.

15. The tissue processor according to claim 11, wherein the heater is controlled to heat the retort lid when the tissue sample is processed with paraffin.

16. The tissue processor according to claim 11, wherein the heater is controlled to heat the retort lid when the retort is cleaned with xylene.

17. The tissue processor according to claim 11, wherein the heater is controlled to heat the retort lid when the retort is cleaned with alcohol.

18. The tissue processor according to claim 11 wherein the heater is controlled to heat the retort lid when the retort is dried.

19. The tissue processor according to claim 11, wherein the operations are programmable to set a predetermined temperature of each of the operations independently.

20. A method of processing a tissue sample by a tissue processor according to claim 1.
